(19) United States
(12) Patent Application Publication
(10) Pub. No.: US 2008/0219111 A1
(43) Pub. Date: Sep. 11, 2008

(54) Drive and Method of Operating the Drive and an Optical Data Carrier Therefore

(75) Inventors: Bart Van Rompaey, Eindhoven (NL); Cornelis Marinus Schep, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/065,902

(22) PCT Filed: Aug. 30, 2006
(86) PCT No.: PCT/IB2006/053011

§ 371 Date: Mar. 6, 2008

(30) Foreign Application Priority Data
Sep. 9, 2005 (EP) 05108274.1
Nov. 16, 2005 (EP) 05110785.2

(51) Int. Cl. G11B 7/00

(52) U.S. Cl. 369/44.27

(57) ABSTRACT

A drive, a method of operating the drive and a hybrid disc, BD9, comprising the physical layer of a dual layer DVD disc, DVD9, and the application layer of a Blu-ray disc (BD). The disc comprises a reserved area containing a modulation code and a file structure of the application layer and a BD-ROM mark for a copy protection system (CPS) according to the established BD-ROM format. The disc is readable by a conventional DVD drive, but the firmware and specific hardware and software (47,48,49) for detecting the BD-ROM mark is used. In this way, present DVD or BD drives need only firmware upgrades.

### AREA OF INVENTION

The present invention relates to a drive and a method of operating the drive for reading an optical data carrier including a copy protection system (CPS) for BD9 (Blu-ray Disc) that re-uses the already available hardware present in BD systems currently under development. The invention also relates to the optical data carrier.

### BACKGROUND OF INVENTION

US published patent application No. 2004/0264694A1 discloses a high-density optical disc, a method for encrypting data and recording the encrypted data thereon. A high-density optical disc, such as a Blu-ray disc-read only memory (BD-ROM) has a helical track comprising data. Data can be encrypted using disc radius information or an address unit (AU) number contained in an AU and then the encrypted data is recorded on the high-density optical disc. Thus, a user holding the optical disc apparatus such as the BD-RE player can be prevented from unlawfully copying data of the BD-ROM to the BD-RE and unlawfully reproducing the copied data.

WO 2004/075187 discloses an information carrier for holding user information. The information carrier comprises access information in the form of access information bits for accessing the user information. The access information bits are stored on the information carrier in a variation of a parameter, which variation is detectable by integration detection. The access information bits are scrambled according to a pre-determined scrambling method. By scrambling the access information bits according to a pre-determined scrambling method, detection of the access information is not possible as long as the scrambling method is not known. Using the integration detection technique only results in the access information, if one knows how the signal obtained after reading-out the area comprising the access information bits must be processed. In this way illegal retrieval of the user information is further prevented.

WO 2004/075188 relates to an information carrier for holding user information. The information carrier comprises access information for accessing the user information. The access information is stored in a pre-determined first region on the information carrier. The information carrier further comprises at least one further region different from the first region, the further region comprising dummy information. The invention is based on the insight that the noise level of a read out signal increases somewhat in the region(s) where the access information is hidden. To avoid this difference in noise level between regions with and without the access information, this access information is assigned for only a specific region of the information carrier, but dummy information is also written in other regions. Due to this, an improved copy protection system against illegal read out of the user information present or to be present on the information carrier is realized.

The technical contents of all three publications are incorporated in the present specification by reference.

A new format is presently under discussion, called BD9. This BD9 format uses the physical layer of a dual layer DVD disc (DVD9) but with the application layer of BD. Thus, the BD9 format is a hybrid format.

The physical appearance of the BD9 disc is substantially the same as a DVD9 disc, including two layers, which may comprise up to 7.95 GB data. A DVD disc has a 0.6 mm cover layer thickness, a track pitch of 740 nm and a channel bit length of 146.7 nm. It uses a laser with wavelength 650 nm for reading having a numerical aperture NA of 0.60 or 0.65.

The application layer is the layer that the user interacts with. It consists of all the interactivity that the user may use to handle the disc, such as menu structures in DVD discs, or the ability to start up small applications, choose subtitles and sound, play games, etc.

The BD9 disc is a ROM disc, i.e. it cannot be recorded on. It uses pits and spaces for coding the data.

In order to arrive at a BD9 disc that is compatible with, and can be read by a DVD drive, the following considerations may apply. The layout of a DVD9 disc is re-defined under the following constraints:

1. A current DVD ROM drive should not crash when reading a BD9 disc. However, the current DVD ROM drive may not be able to access the BD9 data.

2. A current BD ROM drive may be converted so that it can read the BD9 disc by firmware upgrades only, i.e. no hardware changes should be required.

The basic idea is to let a standard DVD ROM drive believe that the disc is a normal DVD9 disc but with a very small main-data area. The main data area should be large enough to at least contain an ISO9660 file system with a single file or a group of files that can inform the user that this is a special BD9 disc. A main data area of 5 MB is more than sufficient for this purpose. Since there are two layers, the main-data area of each layer is only 2.5 MB, and the middle area starts after just 2.5 MB on layer zero. Further discussion of the BD9 approach is given below.

Most BD drives may be able to read one or several of the formats of CD, DVD and BD. As mentioned above, such BD drives should only require firmware changes to be able to read a BD9 disc. However, as mentioned above, a DVD drive without firmware changes should not crash and should be able to recognize that this disc is an incompatible disc, for example by reading the above-mentioned file or group of files arranged in the small DVD like zone, which may display to the user that the discs is a BD9 disc which can only be read by a next generation drive (BD drive).

The BD9 disc cannot (normally) be read by a BD drive, that can read only BD discs, because the physical format of the BD9 disc is that of a DVD disc. However, it is believed that most BD drives also can read DVD (and CD) discs. The BD9 disc cannot be read by a CD drive, that can read only CD discs but not DVD discs.

The BD-ROM format includes among other features a copy protection system and it would be desirable to be able to include a copy protection system also in the BD9 format.

### SUMMARY OF INVENTION

An object of the present invention is to provide a drive and a method of operating the drive so that is adapted to handle the new BD9 format.

Another object of the present invention is to provide a copy protection system for an optical data carrier, that can be handled BD drives that are currently under use or development and the hardware of which should not be needed to be changed.

According to the invention, the CPS key signals from the BD9 disc are arranged so that they resemble the BD signals so that detection of the CPS key can be done by the existing platform. Then, only firmware changes of the BD drive are needed for implementing the BD9 CPS system.

According to an aspect of the invention, there is provided a method of initializing a drive for reading a BD9 format data carrier, which comprises a physical layer of a dual layer DVD format and an application layer of blu-ray, BD, format, comprising: inserting an optical data carrier in the drive for determining format of optical data carrier, such as CD, DVD, BD, and selecting a corresponding reading optical pick-up unit, such as a red laser for CD or DVD or a blue laser for BD; reading disc information comprised in a start-up zone of the data carrier and storing corresponding information in a memory; if the data carrier is of DVD format, determining if the data carrier is of BD9 format; if it is determined that the data carrier is of BD9 format, reading a reserved area comprising a BD-ROM mark using hardware and software adapted for reading said BD-ROM mark and using a optical pick-up unit adapted for reading DVD format; and determining a decryption key and storing the key in a memory.

In an embodiment of the method, said determining if the data carrier is of BD9 format is performed by reading a start-up zone, comprising information, for example type of disc, such as CD/DVD/BD, type of media, such as R, RAM, RW, write strategies, which information is stored in said memory. The method may further comprise: reading the data of the optical data carrier; decrypting the data by means of said decryption key; and emitting a decrypted data signal.

In another aspect, there is provided a drive for initializing the drive for reading a BD9 format data carrier, which comprises a physical layer of a dual layer DVD format and an application layer of blu-ray, BD, format, comprising a receiving device for receiving an optical data carrier in the drive; a selection circuit for determining format of optical data carrier, such as CD, DVD, BD, and selecting a corresponding reading optical pick-up unit, such as a red laser for CD or DVD or a blue laser for BD, for reading disc information comprised in a start-up zone of the data carrier and storing corresponding information in a memory, a selection circuit for determining if the data carrier is of BD9 format and for reading a reserved area comprising a BD-ROM mark, and for selecting hardware and software adapted for reading said BD-ROM mark and using an optical pick-up unit adapted for reading DVD format; whereby said hardware and software are adapted to determine a decryption key and store the key in a memory.

In an embodiment, the optical pick-up unit, which is adapted for reading DVD format, is further adapted for reading a start-up zone, comprising information, such as type of disc, such as CD/DVD/BD, type of media, such as R, RAM, RW, write strategies, which information is stored in said memory. The optical pick-up unit, which is adapted for reading DVD format, may further be adapted for reading the data of the optical data carrier. The drive may further comprise a circuit for decrypting the data by means of said decryption key and for emitting the decrypted data signal.

According to a further aspect of the invention, there is provided an optical data carrier (BD9) comprising a physical layer of a dual layer DVD system (DVD9) and an application layer of a Blu-ray system (BD), comprising a reserved area on the carrier which contains a modulation code and a file structure of the application layer, in which reserved area a BD-ROM mark is arranged, used for a copy protection system.

In an embodiment, the reserved area may be arranged in a zone at the inner radius of the carrier arranged at a radius from about 21.0 mm to 24.0 mm. The advantage of this arrangement is that the drive will be able to read the BD-ROM mark relatively fast.

The reserved area may be arranged in a zone at the inner radius of the carrier arranged at a radius from about 22.2 mm or 22.5 mm to about 24.0 mm in a second layer (L1), while a corresponding zone with radius from about 22.2 mm to about 24.0 mm in a first layer (L0), which normally comprises a burst cutting area (BCA), does not comprise said burst cutting area (BCA), whereby, alternatively, said burst cutting area (BCA) may be arranged in the first layer at a radius from about 21.3 mm to 22.2 mm. The advantage of this arrangement is that the BD-ROM mark can be detected relatively fast and at the same time, the risk of crashing a previously known DVD drive is minimized.

Alternatively, the reserved area may be arranged in a middle zone arranged at a radius from about 24.0 mm to 58.0 mm. Still alternatively, the reserved area is arranged in a zone at the outer radius of the carrier arranged at a radius from about 58.0 mm to 58.5 mm. The advantages of these approaches are that the reserved area may be made as large as required, but at the expense of time during the startup procedure.

In another embodiment, a wobbled pit structure is written in the reserved area and comprises the BD-ROM mark. A modulation code may be a 17 pp modulation code. A main data area may comprise at least one file according to a conventional DVD format such as ISO9660 file system, which file contains information to the user that the carrier is a special BD9 disc. The carrier may be readable by a conventional DVD drive for the small area containing the ISO9660 file system and may be decodable by a BD drive, possibly including firmware adaptations. The BD-ROM mark may be arranged as a wobbled pit structure in said reserved area.

### BRIEF DESCRIPTION OF DRAWINGS

Further objects, features and advantages of the invention will appear from the following detailed description of the invention with reference to embodiments thereof and with reference to the appended drawings, in which:

FIG. 1 is a schematic view of a first embodiment of the layout of the BD9 disc.

FIG. 2 is a schematic view of the information area of a dual layer disc.

FIG. 3 is a schematic view of a second embodiment of the layout of the BD9 disc.

FIG. 4 is a block diagram of a drive including firmware adaptations according to the invention.

### DETAILED DESCRIPTION OF EMBODIMENTS

A disc according to the newly defined BD-ROM physical format comprises the following areas:

The information zone is divided into areas having a ring-shape with specific radius measured from the centrum of the disc.

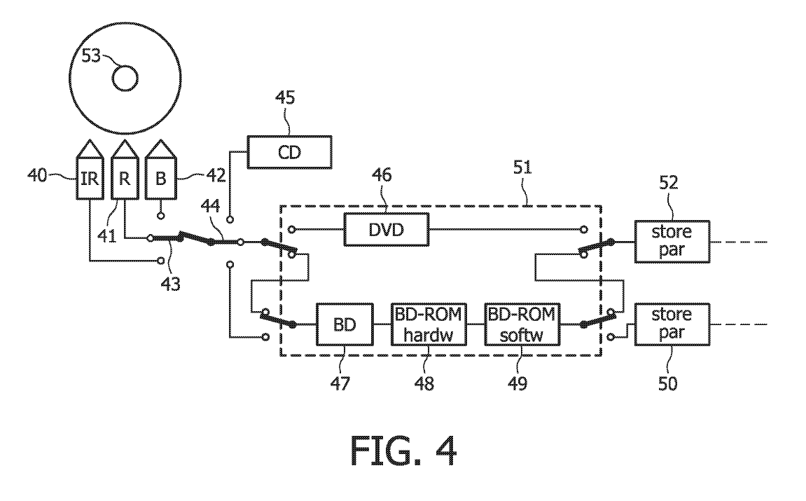

The disc comprises a clamping area from radius 11.5 mm to 16.5 mm in which the disc is physically clamped by the disc attachment system 53 (see FIG. 4) for connection to the drive shaft of a motor spinning the disc by a central hole or opening having a radius of 7.5 mm.

After the clamping area there is a transition area with radius 16.5 mm to 21.0 mm.

Then follows a BCA (burst cutting area) with radius 21.0 to 22.0 mm, comprising certain information, in the form of a series of low reflectance stripes arranged in the circumferential direction. The information in the BCA zone is normally comprised in a single revolution, and repeated several times resembling a bar code.

Thereafter, a lead-in zone 11 starts with radius 22.0 mm to 24.0 mm. The lead-in zone may comprise certain information such as guard 1, PIC (permanent information and control data), guard 2, INFO2, reserved, INFO1.

A data zone is arranged at radius 24.0 mm to 58.0 mm

Finally, a lead-out zone is arranged at radius 58.0 mm to 58.5 mm.

A DVD-ROM disc has the following data:

BCA: 22.3 mm-23.5 mm

Lead-in zone: 23.88 mm-24.0 mm

Data zone 24.0 mm—

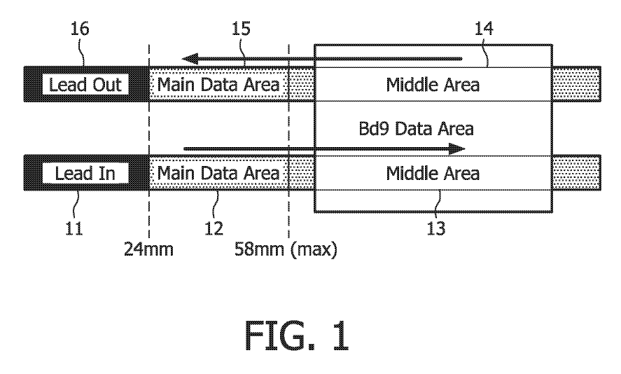

FIG. 1 shows the information zone of a BD9 disc.

After the lead-in zone, there is a Main Data Area 12, with radius from 24.0 mm to 58 mm (max).

After the Main Data Area 12, there is a Middle Area 13, with radius from 58 mm to 58.5 mm. This is the BD9 Data area. The middle area may start earlier, immediately after the small file system, as described below.

The BD9 disc is a dual layer disc, and the same structure is repeated in the other order at the second recording layer, i.e. a Middle area 14, a Main Data area 15 and a lead-out area 16. The BD9 disc is a read-only disc (ROM).

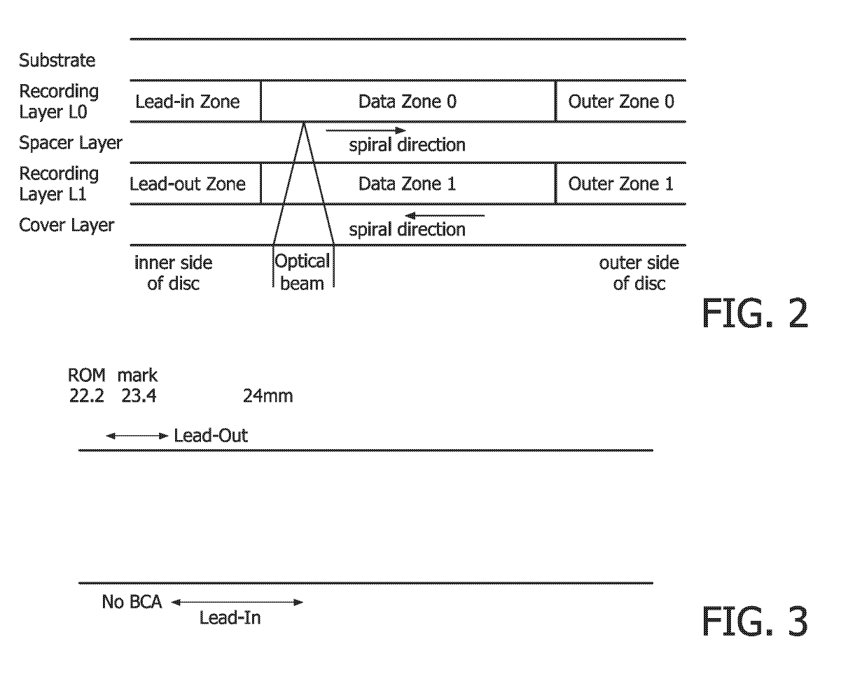

In FIG. 2, a conventional information structure of a BD-RE disc is shown, including a lead-in zone, a data zone 0, an outer zone 0, all in the first recording layer L0; an outer zone 1, a data zone 1, and a lead-out zone, all in the second recording layer L1. Moreover, the positions of the substrate and the cover layer are shown as well as the optical beam.

As mentioned above, the layout of a BD9 disc is redefined under the following constraints:

1. A current DVD ROM drive should not crash when reading a BD9 disc. However, the current DVD ROM drive may not be able to access the BD9 data.

2. A current BD ROM drive may be converted so that it can read the BD9 disc by firmware upgrades only, i.e. no hardware changes should be required.

The basic idea is to let a standard DVD ROM drive believe that the disc is a normal DVD9 disc but with a very small main-data area. The main data area 12 and 15 should be large enough to at least contain an ISO9660 file system (a file system used in DVD according to a general standard) with a single file or a group of files that can inform the user that this is a special BD9 disc. A main data area of 5 MB is more than sufficient for this purpose. Since there are two layers, the main-data area of each layer is only 2.5 MB, which means that the middle area 13, 14 starts after just 2.5 MB on each layer.

In another embodiment the following approach is used instead of making a small DVD session on a BD9 disc and put the content of BD9 in a very large Middle Zone. In some drives, such as for DVD+RW, there is introduced a concept called General Application Area, GAA. This GAA can be used to prevent situations which may cause troubles in existing DVD drives, like for instance a BD9 disc. The GAA area defines a small file system, which can contain a message like: “This is a BD9 disc, which can only be read by a BD player”. Every existing DVD drive does not see anything else except this small disc area and plays the limited content. A BD9 player, however, recognizes this and knows that there is a second file system containing the BD9 info. In this embodiment, no middle zone is needed for BD9, but all data is arranged in the main data area. The current DVD layout remains the same and almost all existing drives know about the GAA concept.

The following guidelines should be followed:

1. The sector headers should be normal

a. Physical address should be normal

b. The Sector Information Byte should mark the disc areas: lead-in, lead-out, main data and middle area. When using the middle area approach, all sectors containing BD9 content are marked “middle area” and are included between radius from about 24.0 mm to about 58.0 mm.

c. The CPRMAI bytes must be all zeros over the entire disc, or used for the CSS encryption of the video in the main-data area. The CPRMAI bytes are related to the CoPyRight MAnagement Information of a DVD disc. They should be zero since a different copyright system is used on BD9. CSS means Content Scrambling System, and is the general name for the DVD copy protection system.

2. The control-data zone should have a normal content for a DVD format:

a. Book Type/Version should be 0x01, which is indicated in a control-data zone comprising information that a drives read upon start up from the disc and comprises basic information of the disc, such as according to which standard the disc is made.

b. All other bytes also normal as if a DVD9 disc.

c. Bytes 1024 . . . 2048, which are arranged in the control data zone, more particular in the Physical Format Information part of the control data zone, are currently reserved in DVD, but can be used to define where the BD9 part is, when using a layout in the middle area. The ROM Mark will be used for positive identification. Thus, this area in the control zone need only to inform the BD9 drive about the boundaries of the BD9 data area and the physical address to logical address mapping for layer 0 and layer 1.

Additional information about the new format BD9 is as follows:

Proposed read-out speed is 3 times the existing ECMA standard used for DVD, and equals 33 Mbps on a red laser disc drive.

There are tighter tolerances on certain parameters, such as eccentricity and imbalance.

The file system is the same as for BD25/50 (UDF2.6).

Application: Same as BD25/50 (BD-MV and BD-J).

Content protection: Same as for BD-ROM 25/50; only minimum changes as needed for different physical discs; Robustness at least at same level as BD-ROM 25/50.

For the BD-ROM disc, a copy protection system CPS has been developed comprising a BD-ROM mark, which is a wobble key detectable using integration detection techniques, see for example WO 2004/075187.

The BD-ROM mark consists of an encryption key that, together with other copy protection measures, is used for decrypting the data present in the data zone of the BD-ROM disc. The BD-ROM mark is read out during the initialization phase of the drive, i.e. before the actual data is read out. Generally, the BD-ROM mark may be access information stored in the PIC zone of the information carrier. The information carrier comprises a so-called Permanent Information & Control data (PIC) zone. In this PIC zone general information about the information carrier and various other information is stored. In this way, a data channel for pre-recorded information with sufficient capacity and data rate may be created. The PIC information is stored in prerecorded pits/spaces but this information can also be stored in pre-recorded high frequency modulated (HFM) grooves, which are modulated in the radial direction with a rather high bandwidth signal. Due to the fact that the information is stored in a wobble channel, a buried channel is created. In order to be able to read out the access information, a reference to the position of the access information in the PIC zone can be retrieved by a certain method. The PIC zone comprises a main data channel, with address unit numbers (AUN). These AUN are used for indicating the starting position of the access information in the PIC zone. This is possible as the wobble channel signal is locked to the data signal (HF-channel). An address is 4 bytes (nibble) (without ECC bytes). As the PIC zone is only situated in a small part of the information carrier, only a limited number of the least significant bits (lsb's) of the 32 bits change within the PIC zone (generally only the first lsb's). These 16 bits are sufficient to determine the position within the PIC zone. The PIC zone extends over some 2000 tracks; suppose that the access information is only present in 20 consecutive tracks, the starting position of this access information being determined by an AUN from the user information. The first 16 lsb's of this AUN are than positioned over the complete PIC zone, for example using an unscrambled modulation. Due to that, it becomes possible, when arriving at a random position in the PIC zone, to read out the first 16 bits of the AUN, to jump to the starting position of the access information, and to read out the access information. In this way, the exact location of the access information is further hidden in the PIC zone, as it is only situated in a certain position in this band, and not throughout the complete band.

The access information is written in the PIC zone of the disc using a wobbled pit structure. The main data contained in the pit structure consists of the usual PIC information (drive revocation information, disc information). The access information can be part of a key needed to decrypt the user information on the disc. The amplitude of the wobble is small, say 5-10 nm peak to peak. In this way, the wobble signal is very noisy and impossible to copy directly.

For the BD9 disc, which is a modified DVD disc having the application layer of the Blu-ray system, it would be desirable to use a similar system for copy protection as already proposed for the BD-ROM disc. In this way, the same hardware and software used for the BD-ROM copy protection system can be used. The BD drive can be modified to include the copy protection system by including the software already developed for the BD-ROM system.

This object is achieved according to the present invention by transforming the BD ROM mark used in the BD-ROM system to the BD9 system. The BD9 disc is further adjusted so that new BD drives can read this file. New BD drives are normally compatible with the previous DVD system, so they can read the BD9 disc, which physically is a DVD disc.

In order to realize this, a special area is reserved on the BD9 disc that contains a modulation code (17 pp modulation code) used by the BD system and the full RUB (recording unit block) structure of the BD system instead of the EFMPlus RLL (run length limited) modulation code and the frame structure used by the DVD system. The modulation code used by the BD system is the 17 PP modulation code with run-lengths ranging from 2 T to 8 T (1,7 RLL code), while the modulation code used by the previous DVD system is 2,10 code with run-lengths ranging from 3 T to 11 T. For an explanation of the modulation code, see for example the ECMA standard nr 267, which specifies 120 mm DVD-Read-Only disc and is publicly downloadable from the ECMA website.

The special area can be located in the lead-in area, the lead-out area or the middle area of the disc. In the special area, the data is written in BD-ROM format with 17 pp modulation code. In this area, a wobbled pit structure is written to include the physical BD-ROM mark. This means that the existing hardware for detecting the BD-ROM mark developed for the BD copy protection system can be used for BD9 as well. This hardware is included in all new BD drives. Moreover, the same software can be used.

In the same way as in BD-ROM, the BD9 mark will consist of an encryption key that, together with other copy protection measures, is used for decrypting the data present in the data zone of the BD9 disc.

The wobble amplitude should be changed such that the same detection time is reached as in the BD-ROM mark case. Since the read out time does not change much when 3 times DVD speed is used as reference velocity for BD9, a proper scaling of the wobble amplitude should result in the same detection time of the key.

It might be necessary to increase the track pitch from 350 nm used in the BD PIC area where the BD ROM mark is written to 740 nm of the DVD system. The track pitch and channel bit length can be changed somewhat if this makes it easier for the drive to detect the BD ROM mark for BD9.

The track pitch for the BD ROM mark is 350 nm while the track pitch in the data zone is 320 nm. If this track pitch is scaled with λ/NA, the following table is obtained:

| BD-ROM | BD9, NA = 0.6 | BD9, NA = 0.65 |
|---|---|---|
| 320 nm | 727 nm | 671 nm |
| 350 nm | 796 nm | 734 nm |

The track pitch of DVD is 740 nm, which is larger then the scaled values from 320 nm in the table. In the worst case, the track pitch for the BD9 ROM mark needs to be 796 nm, e.g. 800 nm.

The location of the BD9 ROM mark may be at the following positions:

1) The BD9 ROM mark is arranged in the lead-in zone 11 (see FIG. 1). There are two INFO (or buffer) zones in the DVD system, which are respectively 2724 mm and 2905 mm long along the track. The INFO1 zones may contain 16 RUB's scaled to BD9 and the INFO2 zone may comprise 17 RUB's (track pitch 740 nm). The available RUB's is relatively low in this solution.

2) The BD9 ROM mark is arranged in the middle zone 13, 14. The number of sectors in the middle zone is not specified in the DVD case, so we can use all the space needed for the detection of the BD9 ROM mark. If a RUB is 175 mm long, we need 175 m for 1000 RUB's, which may be arranged at the outer periphery of the disc between radius 58.41 mm to 58.5 mm.

3) The BD9 ROM mark is arranged in the lead-out zone 16, which is at the inner radius of the disc (if OTP). Then 1000 RUB's will fit between the radius 22.6 mm to 23.56 mm assuming a track pitch of 800 nm.

The position of the 17 pp area on BD9 should be selected so that it causes no start up problems whatsoever with the existing DVD startup configuration. This is certainly so for the middle zone of the BD9 disc.

Other considerations result in that the lead-in or lead-out zone can be used, such as in layer zero closest to the lens.

The contents of the main data area 12, 15 can be any data, which means that this area can be used for including further copy protection measures.

The parameters for a BD-ROM have to be modified for the BD9 format.

The parameters for a DVD are the following:

| wavelenght | 650 | nm |
|---|---|---|
| NA_1 | 0.6 | |
| NA_2 | 0.65 | |
| cbl (DL DVD) | 146.7 | nm |
| tp (track pitch) | 740 | nm |
| read out velocity | 3.84 | m/s |

The parameters for a BD-ROM are the following:

| wavelength | 405 | nm |
|---|---|---|
| NA_1 | 0.85 | |
| cbl (@23.3BG) | 80 | nm |
| cbl (@25BG) | 74.5 | nm |
| tp (@PIC) | 350 | nm |
| tp (outside PIC) | 320 | nm |
| read out velocity (@23.3BG) | 5.28 | m/s |
| read out velocity (@25BG) | 4.917 | m/s |

This parameters result in a linear scaling factor:

Scaling factor_{—}1 (BD9_{—}1) 2.273662551

Scaling factor_{—}1 (BD9_{—}2) 2.098765432

The length of a 17 pp RUB length scaled to BD9 would be:

BD BD9_{—}1 BD9_{—}2

NA=0.85 NA=0.60 NA=0.65

length of RUB (@23.3 BG) 76.97088 175.0058074 161.5438222

length of RUB (@25 BG) 77.679132 162.9741581 150.4376844

The signal frequencies for BD9 ROM mark at 3 times DVD readout speed would be (calculated relative to the speed of the BD):

| BD-ROM | BD9_1 | BD9_2 |
|---|---|---|
| NA = 0.85 | NA = 0.60 | NA = 0.65 |
| 23.3 GB 1 | 0.959605 | 1.039572 |
| 25 GB 1 | 1.030448 | 1.116319 |

Different layouts are possible in the lead-in zone. The following radius positions are contemplated:

Lay-out 1 resulting in 351 RUB's for the BD9 ROM mark:

| | Start radius (mm) | End radius (mm) |
|---|---|---|
| DVD BCA | 22.3 | 23.55 |
| BD9 ROM mark | 23.55 | 23.88 |
| Lead-in zone | 23.88 | 24 |
| (4096 DVD sectors) | | |
| Data zone | 24 | — |

Lay-out 2 resulting in 1737 RUB's for the BD9 ROM mark:

| | Start radius (mm) | End radius (mm) |
|---|---|---|
| DVD BCA | 21.3 | 22.2 |
| BD9 ROM mark | 22.2 | 23.88 |
| Lead-in zone | 23.88 | 24 |
| (4096 DVD sectors) | | |
| Data zone | 24 | — |

Lay-out 3 resulting in 978 RUB's for the BD9 ROM mark:

| | Start radius (mm) | End radius (mm) |
|---|---|---|
| BD9 ROM mark | 21.3 | 22.3 |
| DVD BCA | 22.3 | 23.55 |
| Lead-in zone | 23.88 | 24 |
| (4096 DVD sectors) | | |
| Data zone | 24 | — |

The channel bit length (cbl) of the 17 pp modulation code should be adapted to a length that is close to that of DVD, which is 146.7 nm for dual layer DVD. The channel bit length of BD 25 GB is 75 nm resulting in an increase of 1.956. Also the track pitch will increase from 350 nm to 740 nm of DVD, which again is about a factor of 2. The track pitch and the cbl can be changed somewhat if this makes it easier for the drive to detect the BD ROM mark for BD9.

Further considerations are:

The content of the main channel in the 17 pp part of the BD9 disc can be arbitrary. The main channel is the information that is contained in the normal data signal from the pits and lands.

In DVD there is no specification for the radial Push-Pull PP signal, which controls the radial position of the optical tracking unit.

This PP signal is needed for the detection of the BD ROM mark. Thus, the BD9 disc will require having a sufficiently large PP signal. The normalized PP signals can be made comparable to those in BD ROM. In such a way, BD9 ROM marks can be produced having small invisibility and detectability and the same wobble amplitudes that are used in BD-ROM. Relevant BD-ROM signals for detecting the BD-ROM mark are the radial PP signal and the HF signal.

The position of the 17 pp area on BD9 can be chosen such that it causes no start up problem whatsoever with the existing DVD startup configurations. A possible position is to put the 17 pp area in the middle zone 13, 14 of the BD9 disc.

Another embodiment of arrangement of the BD ROM mark is disclosed in FIG. 3. The BD ROM mark is arranged after the lead-out zone in the second layer, L1, at radius between 23.4 mm and 22.2 mm. In this embodiment, no burst cutting area BCA is arranged before the lead-in zone in the first layer, L0, because there is a risk that the BCA could interfere with the read out of the ROM mark in L1, because the location of the normal DVD BCA is overlapping with the area in which the BD ROM mark is arranged. However, it is possible to use a BD BCA if a BCA is desired on the BD9 disc. This BD BCA uses the area from 21.3 mm to 22.2 mm and does not interfere with the BD ROM mark in L1. It is possible to arrange some margins by arranging the ROM mark to end at 22.5 mm, because there is sufficient space. Thus, the BD ROM mark area from 22.2 mm (22.5 mm) to 23.4 mm on layer L1 of the BD9 disc contains the 17 pp data to be able to write the ROM mark according to the same format as defined in BD ROM so that the same hardware can be used for its detection.

In BD-ROM detection time of the BD ROM mark is typically around 30 ms. Since in BD9 the reference velocity might be the same as DVD dual layer, 3.84 m/s, which is 1.28 times smaller than 4.917 m/s for BD 25 GB and also the scaled RUB from the BD-ROM to BD9 is a factor 1.956 larger, the typical detection time will be somewhat larger, typically 75 ms which is acceptable.

What is done in the current description of the implementation for BD9 is that the BD9 disc contains the physical layer of DVD and only has a small region where 17 pp code is present to allow the CPS information to be written there. Another possibility is to have a BD9 disc that does not have the DVD physical layer but a scaled to DVD physical layer of BD (so that the data can be read out with DVD optics.) Then the whole disc will contain 17 pp code, and thus BD9 will just be a full format BD-ROM disc that is scaled to DVD. However this has a drawback that the ECC blocks of the scaled BD format will be spread over more than one revolution of the disc at the inner radius. This reduces the error correction capabilities of the system since radial scratches are likely to scratch out bytes in the same ECC block.

A conventional DVD drive can be adapted to read a BD9 disc by including hardware from the present BD ROM drives for detecting the BD9 ROM mark and including firmware adaptations.

The disc comprise data in the format of the BD9 in the middle area, and only a small file of e.g. 5 MB in the DVD format in the main data area. However, it is possible to arrange larger files, which can be read by the DVD drive, for example including certain data. Thus, the main data area can have any size, such as 700 MB and the rest can be used for the BD9 data.

When the drive starts up, the following actions are undertaken. The first thing that happens is that the drive will try to recognize the disc as either CD, DVD or BD. There are algorithms for that.

As soon as the drive knows that it is a CD/DVD or BD it will switch to the right optics in the Optical Pick-Up Unit (OPU) required for reading that particular format.

Then the drive will go to the lead-in area of the disc to read a ‘start-up’-zone, which contains extra information about the disc, called the Disc information. This can be (and not exclusively): reconfirmation of the disc (CD, DVD or BD), type of media (R, ROM or RW), write strategies in case of the writeable formats, etc.

In order for existing DVD-only drives not to crash, it is needed to avoid that 17 pp code, which it cannot recognize, is encountered during the start-up process. So putting the BD-ROM mark in the lead-in zone may cause problems in this regard.

Alternatively, the BD-ROM mark may be arranged in the middle zone or outer radius of the disc. However, the drawback of this arrangement is that it is not so convenient for start-up: the drive first will recognize the BD9 disc as a DVD disc, and will start up with DVD optics and will start reading the Disc information, where it will be notified that it is in fact a BD9 disc. The optics is the right one, but an extra startup procedure is required: namely finding the BD-ROM mark. If this is located in the middle zone or outer zone, the drive needs to go there, which is at the outer side of the disc, while the OPU is currently located in the lead-in zone. A large jump takes valuable startup time, which means that it is an advantage to have the BD-ROM mark as close a possible to the lead-in zone without interfering with the start up process of the existing DVD-only drives.

Thus, the embodiment shown in FIG. 3 is a good alternative. It is located in a BCA area, but then at the layer farthest away from the objective lens. It is close to the lead-in but far enough away from it to avoid in most cases crashing of a DVD-only drive on start-up.

The normal start-up procedure is the following:

1) distinguish between CD/DVD/BD

2) select the correct OPU and select the right CD/DVD/BD circuit

3) start reading Disc Information

4) start reading/writing data

In case of a BD drive capable of reading BD9 this procedure changes somewhat. The firmware is adapted so that the following happens:

1) distinguish between CD/DVD/BD

2) select the correct OPU

3) start reading Disc Information

4) If no BD9 disc, select the right CD/DVD/BD circuit depending on outcome of step 1)

5) If a BD9 disc is inserted: select DVD OPU, go to ROM mark location and select BD circuit for detection of the BD-ROM key

6) After key retrieval go to BD9 data area and switch to DVD circuit for reading back the data.

FIG. 4 discloses a block diagram, in which a drive has been provided with firmware adaptations in order to enable reading of the BD9 format.

The drive includes an optical pick-up unit comprising an infrared laser 40, a red laser 41 and a blue laser 42, which are connected to a first selector 43 and a second selector 44, for connecting one of the lasers 40, 41, 42 to circuits for handling the signals for CD 45, for DVD 46 and for BD 47. The drive comprises algorithms for determining if the inserted disc is a CD, DVD or BD, which controls the selectors 43, 44.

The BD circuit 47 comprises hardware 48 and software 49 specifically adapted for the recognition of the BD-ROM mark. These hardware and software are used for detecting the BR-ROM mark, from which a decryption key may be determined and stored in a memory 50 together with other parameters.

In accordance with the present invention, there is included another selector 51, which is arranged to insert circuit 47 and hardware 48 and software 49, in the DVD circuit 46. Thus, when a BD9 disc is inserted in the drive, it is determined that the disc is a DVD type disc readable by the red laser 41, which is selected. The DVD circuit 46 is selected by the selector 44. At the reading of the lead-in zone, it is recognized that the disc is a BD9 disc, which activates the selector 51 to switch in the circuit 47 and hardware 48 and software 49 for the time needed to detect the CPS key. The circuit 47 and hardware 48 and software 49 recognize and determine the decryption key, which is then stored in a parameter memory 52 together with other parameters. It is noted that the selectors 43, 44, 51 may be embodied as software in the program controlling the drive. Although FIG. 4 has indicated boxes or circuits for performing certain method steps, it is realized that most of the method steps may be performed by software, as is customary in the field.

In FIG. 4 it is indicated that the same circuit 47, hardware 48 and software 49 are used for the BD9 detection as for the traditional BD detection. However, the software 49 may be duplicated instead of used for two purposes. According to the invention, however, at least the hardware 48 is used for dual purposes, so that no hardware additions are required. However, in new drives including BD9 compatibility, the hardware may be duplicated, if desired.

After the ROM mark is detected, switch 51 is switched again to the DVD circuits 46 for the reading back of data in EFMplus code.

It should be emphasized that when used in this specification and claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. Reference signs in the claims are provided merely as a clarifying example and shall not be construed as limiting the scope of the claims in any way.

Although the present invention has been described above with reference to specific aspects and embodiments of the invention, it is not intended to be limited to the specific form set forth herein. Rather, the invention is limited only by the accompanying claims and, other embodiments than the specific above are equally possible within the scope of these appended claims. The invention is only limited by the appended patent claims.

1. A method of initializing a drive for reading a BD9 format data carrier, which comprises a physical layer of a dual layer DVD format and an application layer of blu-ray, BD, format, comprising
inserting an optical data carrier in the drive for determining format of optical data carrier, such as CD, DVD, BD, and selecting a corresponding reading optical pick-up unit, such as an infrared laser for CD, a red laser for DVD or a blue laser for BD;
reading disc information comprised in a start-up zone of the data carrier and storing corresponding information in a memory;
characterized by
if the data carrier is of DVD format, determining if the data carrier is of BD9 format;
if it is determined that the data carrier is of BD9 format, reading a reserved area comprising a BD-ROM mark using hardware and software (47,48,49) adapted for reading said BD-ROM mark and using a optical pick-up unit (41) adapted for reading DVD format; and
determining a decryption key and storing the key in a memory.

2. The method of claim 1, wherein said determining if the data carrier is of BD9 format is performed by reading a start-up zone, comprising information such as type of disc, such as CD/DVD/BD, type of media, such as R, RAM, RW, write strategies, which information is stored in said memory.

3. The method of claim 1, further comprising:
reading the data of the optical data carrier;
decrypting the data by means of said decryption key;
emitting a decrypted data signal.

4. A drive for performing the method of claim 1, for initializing the drive for reading a BD9 format data carrier, which comprises a physical layer of a dual layer DVD format and an application layer of blu-ray, BD, format, comprising
a receiving device (53) for receiving an optical data carrier in the drive;
a selection circuit (43,44) for determining type of optical data carrier, such as CD, DVD, BD, and selecting a corresponding reading optical pick-up unit (40,41,42), such as an infrared laser for CD, a red laser for DVD or a blue laser for BD, for reading disc information comprised in a start-up zone of the data carrier and storing corresponding information in a memory (50,52);
characterized by
a selection circuit (51) for determining if the data carrier is of BD9 format and for reading a reserved area comprising a BD-ROM mark, and for selecting hardware and software (47,48,49) adapted for reading said BD-ROM mark and using a optical pick-up unit (41) adapted for reading DVD format; whereby said hardware and software (47,48,49) are adapted to determine a decryption key and store the key in a memory (52).

5. The drive of claim 4, wherein said optical pick-up unit (41) adapted for reading DVD format, is further adapted for reading a start-up zone, comprising information such as type of disc, such as CD/DVD/BD, type of media, such as R, RAM, RW, write strategies, which information is stored in said memory.

6. The drive of claim 4, wherein said optical pick-up unit (41) adapted for reading DVD format, is further adapted for reading the data of the optical data carrier.

7. The drive of claim 6, further comprising a circuit (46) for decrypting the data by means of said decryption key and for emitting the decrypted data signal.

8. An optical data carrier (BD9) comprising a physical layer of a dual layer DVD system (DVD9) and an application layer of a Blu-ray system (BD), characterized by
a reserved area on the carrier, which contains a modulation code, in which reserved area a BD-ROM mark is arranged, used for a copy protection system.

9. The carrier of claim 8, wherein the reserved area is arranged in a zone at the inner radius of the carrier arranged at a radius from about 21.0 mm to 24.0 mm.

10. The carrier of claim 9, wherein the reserved area is arranged in a zone at the inner radius of the carrier arranged at a radius from about 22.2 mm or 22.5 mm to about 24.0 mm in a second layer (L1), while a corresponding zone with radius from about 22.2 mm to about 24.0 mm in a first layer (L0), which normally comprises a burst cutting area (BCA), does not comprise said burst cutting area (BCA).

11. The carrier of claim 10, in which said burst cutting area (BCA) is arranged in the first layer (L0) at a radius from about 21.3 mm to 22.2 mm.

12. The carrier of claim 8, wherein the reserved area is arranged in a middle zone arranged at a radius from about 24.0 mm to 58.0 mm.

13. The carrier of claim 8, wherein the reserved area is arranged in a zone at the outer radius of the disc arranged at a radius from about 58.0 mm to 58.5 mm.

14. The carrier of claim 8, wherein a wobbled pit structure is written in the reserved area and comprising the BD-ROM mark.

15. The carrier of claim 8, wherein the modulation code is a 17 pp modulation code.

16. The carrier of claim 8, wherein a main data area comprises at least one file according to a conventional DVD format, such as ISO9660 file system, which file contains information to the user that the carrier is a special BD9 carrier.

17. The carrier of claim 8, which carrier is readable by a conventional DVD drive and is decodable by a BD drive including only firmware adaptations.

18. The carrier of claim 8, in which the BD-ROM mark is arranged as a wobbled pit structure in said reserved area.
